(19) United States
(12) Patent Application Publication
(10) Pub. No.: US 2026/0366884 A1
(43) Pub. Date: Nov. 19, 2026

(54) Real-Time Overhead Satellite Tracking System for Individual Vehicles

(71) Applicant: Martin Ray Hawley, Chula Vista, CA (US)

(72) Inventor: Martin Ray Hawley, Chula Vista, CA (US)

(21) Appl. No.: 19/210,896

(22) Filed: May 16, 2025

(51) Int. Cl. G01C 21/36

(52) U.S. Cl. CPC G01C 21/3602; G01C 21/3691

(57) ABSTRACT

A real-time satellite-based vehicle tracking system provides individual drivers with overhead imaging of upcoming road conditions. Each vehicle is equipped with a satellite receiver that acquires live, high-resolution imagery from low-orbit satellites, displaying a forward view of one to two miles. The system incorporates AI to identify and classify nearby vehicles, and road hazards using predictive analytics to anticipate traffic flow. An intuitive interface—dashboard-mounted or mobile—enables hands-free voice control, allowing drivers to request alternate routes, zoom into specific areas, or receive hazard alerts through natural language commands. If satellite data is unavailable, the system can switch to alternate imaging sources such as drones or roadside cameras. This invention advances GPS-based systems by delivering real-time, personalized traffic visuals and interactive AI-driven guidance, supporting safer and more efficient travel.

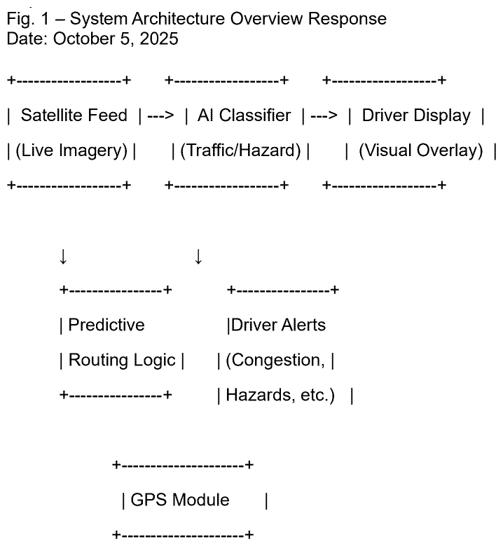

### CROSS REFERENCE TO RELATED APPLICATIONS

(Not applicable. No prior filings.)

### STATEMENT REGARDING FEDERALLY SPONSORED RESEARCH OR DEVELOPMENT

(Not applicable. No development with government funding.)

### THE NAMES OF THE PARTIES TO A JOINT RESEARCH AGREEMENT

(Not applicable. No development under a partnership agreement.)

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

(Not applicable. No submitted material via USPTO systems.)

### STATEMENT REGARDING PRIOR DISCLOSURES BY THE INVENTOR OR A JOINT INVENTOR

(Not applicable. No publicly disclosed aspects of my invention prior to filing.)

### BACKGROUND OF THE INVENTION

### Field of the Invention

The present invention relates to real-time vehicle tracking and navigation systems, specifically, a satellite-based overhead imaging system that enhances drivers' awareness of upcoming road conditions beyond traditional GPS methods.

### Description of Related Art

Current vehicle navigation systems rely primarily on GPS mapping, traffic reports, and predictive route suggestions, but lack real-time, overhead visual imaging tailored to individual drivers. In congested areas, particularly when surrounded by large vehicles (e.g., trucks, buses, emergency vehicles), drivers experience limited visibility that can lead to navigation inefficiencies, delays, and potential safety hazards.

While traffic cameras and aerial surveillance exist, they do not provide personalized overhead imaging directly to individual vehicles. Additionally, current systems lack AI-driven traffic classification and predictive analytics designed for real-time hazard detection.

### BRIEF SUMMARY OF THE INVENTION

This invention introduces a real-time satellite-based tracking system for individual vehicles, delivering live aerial images of upcoming road conditions. Each vehicle is equipped with a satellite receiver that acquires high-resolution imagery from low-orbit satellites, displaying a forward view of one to two miles.

The system incorporates AI-based object identification to classify surrounding vehicles (trucks, cars, motorcycles) and predictive analytics to forecast congestion and hazards. Voice-command functionality allows drivers to interact with the system hands-free, requesting alternative routes or specific viewpoints (e.g., “Show me ½ mile ahead”).

If satellite data is unavailable, the system can switch to alternative imaging sources such as low-altitude drones or roadside aerial cameras, ensuring continuous functionality in extreme weather conditions.

This technology advances traditional GPS-based navigation by providing real-time traffic visuals and AI-driven guidance, supporting safer and more efficient travel.

### BRIEF DESCRIPTION OF THE SEVERAL VIEWS OF THE DRAWING(S)

(None)

### DETAILED DESCRIPTION OF THE INVENTION

The system consists of several key components working together to provide personalized, real-time overhead road imaging for individual drivers:

### 1. Satellite Communication & Imaging

Vehicles are equipped with advanced satellite receivers that acquire real-time low-orbit satellite imagery, providing high-resolution images that refresh rapidly based on the driver's geographic location.

These images offer aerial views of traffic conditions up to two miles ahead, improving route planning and hazard detection.

### 2. AI-Based Object Identification & Traffic Forecasting

The system employs advanced AI-driven algorithms to accurately identify surrounding vehicles, including trucks, cars, motorcycles, and emergency vehicles. AI algorithms classify objects and predict traffic movement trends, congestion patterns, and high-risk areas, helping drivers make informed navigation decisions.

### 3. Interactive Display with Voice Commands

The overhead satellite feed provides a live, dynamic aerial view, displaying real-time motion visuals of actual vehicles, traffic flow, road conditions, and obstacles. This continuously updated feed appears on a dashboard-mounted screen or mobile application, offering drivers a moving, real-time perspective of the road ahead. Users can adjust viewpoints, receive customized road hazard alerts, and zoom into specific traffic scenarios.

### 4. Voice-Command Functionality

Enables hands-free interaction with prompts such as:
“Show me ahead ½ Mile.”
“Find an alternate route around the accident ahead.”
“Identify emergency vehicles nearby.”

AI integration allows the system to interact with existing virtual assistants such as Alexa, Siri, or Google Assistant, enhancing driver convenience.

### 5. Alternative Imaging Methods

If satellite imagery is unavailable (e.g., during extreme weather), the system switches to low-altitude drones or roadside aerial cameras to provide real-time visual data. This ensures consistent functionality, preventing navigation disruptions in severe conditions.

1. A vehicle-based imaging and hazard-awareness system comprising:
a satellite imaging module configured to receive overhead image data representing an area surrounding a vehicle;
a vehicle telematics module configured to determine a current position, speed, and heading of the vehicle;
an image alignment module configured to align the overhead image data with a road map based on the current position, speed, and heading of the vehicle;
an object detection and classification module configured to analyze the aligned overhead image data to detect and classify objects including vehicles, pedestrians, and roadside hazards, and to determine a location of each detected object relative to the vehicle;
a predictive hazard and routing module configured to identify potential hazards based on the detected objects and to predict an effect of the potential hazards on a travel path of the vehicle; and
a driver-centric visualization module configured to generate, for display within the vehicle, a real-time visual representation showing the vehicle and the detected objects, including objects located beyond a line-of-sight of the driver, based on the aligned overhead image data and the detected objects.

2. The system of claim 1, wherein the satellite imaging module is configured to receive image data at a predetermined update interval to provide near real-time overhead imagery.

3. The system of claim 1, wherein the object detection and classification module is configured to distinguish between at least two classes of vehicles selected from: passenger cars, small trucks, large trucks, and commercial transport vehicles.

4. The system of claim 1, wherein the object detection and classification module is further configured to detect pedestrians located outside of vehicles.

5. The system of claim 1, wherein the predictive hazard and routing module is configured to identify a stopped vehicle as a potential hazard when the detected vehicle exhibits no motion over a threshold time period.

6. The system of claim 1, wherein the driver-centric visualization module displays graphical representations of detected vehicles, pedestrians, and hazards based on the overhead image data.

7. The system of claim 1, wherein the driver-centric visualization module highlights potential hazards using a visual indicator selected from: color change, flashing icon, or enlarged icon.

8. The system of claim 1, wherein the image alignment module is configured to determine a region of interest ahead of the vehicle based on the vehicle's heading.

9. The system of claim 1, wherein the predictive hazard and routing module is configured to generate a recommended alternate route when a detected hazard is located along the vehicle's current travel path.

10. The system of claim 1, wherein the driver-centric visualization module displays objects located beyond a line-of-sight obstruction selected from: hills, curves, or large vehicles.

11. The system of claim 1, wherein the satellite imaging module is configured to receive image data from at least one of: a satellite, an aerial drone, or an aircraft-based imaging platform.

12. The system of claim 1, wherein the object detection and classification module determines a motion vector for each detected object based on sequential overhead image frames.

13. The system of claim 1, wherein the driver-centric visualization module updates the visual representation at a rate corresponding to the update interval of the overhead image data.
